(19) United States
(12) Patent Application Publication
(10) Pub. No.: US 2004/0146342 A1
(43) Pub. Date: Jul. 29, 2004

(54) Connection of tool handle with tool bit

(76) Inventor: Yu-Cheng Lin, Taichung (TW)

Correspondence Address: CHARLES E. BAXLEY, ESQUIRE, Hart, Baxley, Daniels & Holton, 59 John St, 5Fl, New York, NY, 10038, US

(21) Appl. No.: 10/352,647

(22) Filed: Jan. 27, 2003

(51) Int. Cl. B25G 3/18

(52) U.S. Cl. 403/324

(57) ABSTRACT

A connector for connecting a tool handle with a tool bit includes a shank, a spring, a detent and a switch. The shank includes a first end, a second end, a non-circular insert formed at the second end for insertion in a corresponding hole defined in the tool bit, a terminal hole extending therein obliquely with respect thereto and a peripheral hole communicated with the terminal hole. The spring is inserted in the terminal hole. The detent is movably inserted in the terminal hole and includes a first end biased by means of the spring and a second end extensible from the terminal hole for engagement with the wall of the hole defined in the tool bit. The switch is connected with the detent through the peripheral hole.

### BACKGROUND OF INVENTION

1. Field of Invention

The present invention relates to a tool including a handle and a tool bit for releasable engagement with the handle and, more particularly, to a connector for connecting the handle with the tool bit.

2. Related Prior Art

U.S. Pat. No. 5,531,140 discloses a conventional connector including a rod 10, a ball detent 15, a control bar 20, a spring 24 and a button 30. The rod 10 defines an axial cavity 13, a hole 14 communicated with the axial cavity 13 and a hole 11 communicated with the axial cavity 13. The control bar 20 includes a slot 21 longitudinally extending therein. The slot 21 including a long opening in a first side and a short opening in a second side opposite to the first side. In addition, a deep recess 22 and a shallow recess 22 are defined in the second side of the rod 20. The button 30 includes a hook 31 formed at an end and an inclined edge 32 formed next to the hook 31. The ball detent 15 is put in the hole 14. The wall of the hole 14 is processed so as to trap the ball detent 15 in the hole 14. The spring 24 is received in the axial cavity 13. The control bar 20 is inserted into the axial cavity 13. The control bar 20 is biased by means of the spring 24. The button 30 is partially inserted into the hole 11. The hook 31 is received in the long opening of the slot 21 and the inclined edge 32 is received in, the short opening of the slot 21. Normally, the ball detent 15 is partially received in the shallow recess 23 and partially inserted from the hole 14 for locking a tool bit. The button 30 can be pushed in order to move the control bar 20 further into the axial cavity 13. Thus, the ball detent 15 is partially received in the deep recess 22 and hidden in the hole 14.

U.S. Pat. No. 4,938,107 discloses a wedge locking socket device with an extension shank 9 and a socket 21. The extension shank 9 includes a driving portion 12. The socket 21 defines a recess for receiving the driving portion 12. The driving portion 12 includes a shoulder 58 formed thereon, a slot 10 defined therein and a hole 19 communicated with the slot 10. A limiting collar 52 is mounted on the driving portion 12 with an end located against the shoulder 58. A spring 17 is mounted on the driving portion 12. A sleeve 15 is mounted on the driving portion 12. The sleeve 15 includes two rings 28 and 29 formed on an internal side. The spring 17 is compressed between the limiting collar 52 and the ring 28. Two ball detents 22 and 24 are put in the hole 19. A control bar 14 is put in the slot 10. The control bar 14 includes a spur 16 and an inclined edge 22. The spur 16 is held between the rings 28 and 29. The spring 17 pushes the sleeve 15 and therefore the control bar 14 towards the ball detents 22. Because of engagement of the inclined edges 25 with the ball detent 22, the control bar 14 and the ball detent 24 are moved outwardly so as to abut against two opposite walls 31 of the recess defined in the socket 21. The sleeve 15 and therefore the control bar 14 can be moved from the ball detent 22 in order to disengage the control bar 14 and the ball detent 24 from the walls 31.

### SUMMARY OF INVENTION

It is the primary objective of the present invention to provide a structurally simple connector for connecting a tool with a tool bit.

According to the present invention, a connector for connecting a tool handle with a tool bit includes a shank, a spring, a detent and a switch. The shank includes a first end, a second end, a non-circular insert formed at the second end for insertion in a corresponding hole defined in the tool bit, a terminal hole extending therein obliquely with respect thereto and a peripheral hole communicated with the terminal hole. The spring is inserted in the terminal hole. The detent is movably inserted in the terminal hole and includes a first end biased by means of the spring and a second end extensible from the terminal hole for engagement with the wall of the hole defined in the tool bit. The switch is connected with the detent through the peripheral hole.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a connector according to a first embodiment of the present invention.

FIG. 2 is an exploded view of the connector shown in FIG. 1.

FIGS. 3-7 are cross-sectional views of the connector shown in FIG. 1.

FIG. 8 is a perspective view of a connector according to a second embodiment of the present invention.

FIG. 9 is a perspective view of a connector according to a third embodiment of the present invention.

### DETAILED DESCRIPTION OF EMBODIMENTS

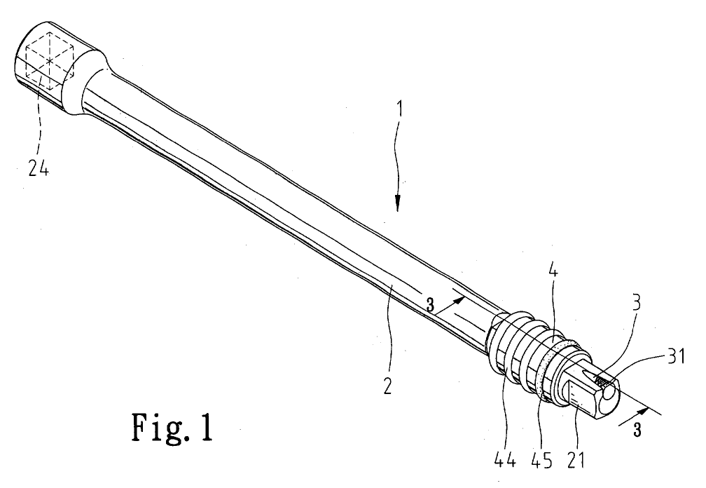

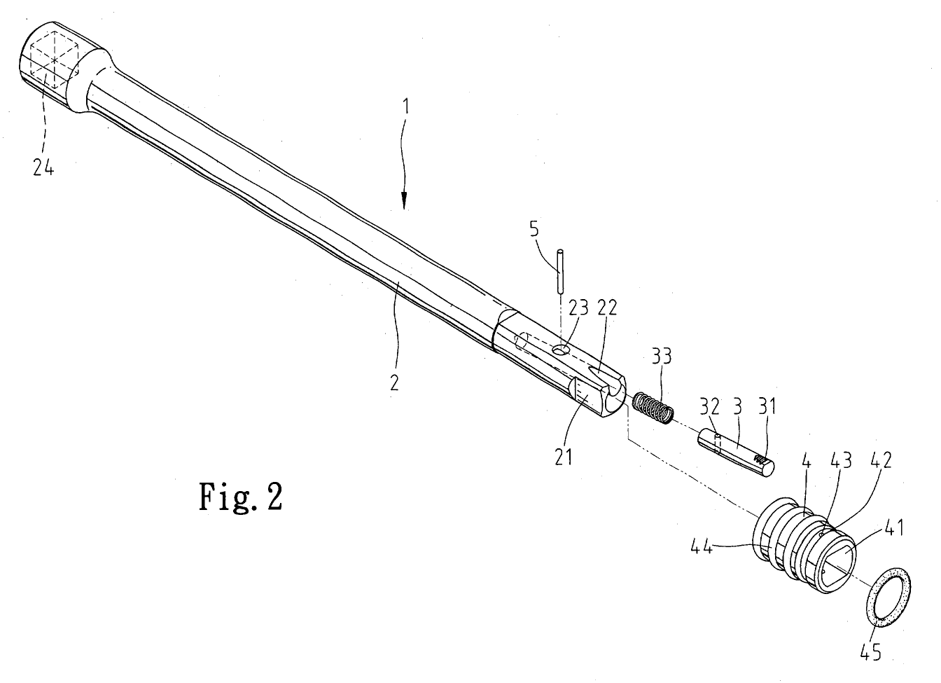

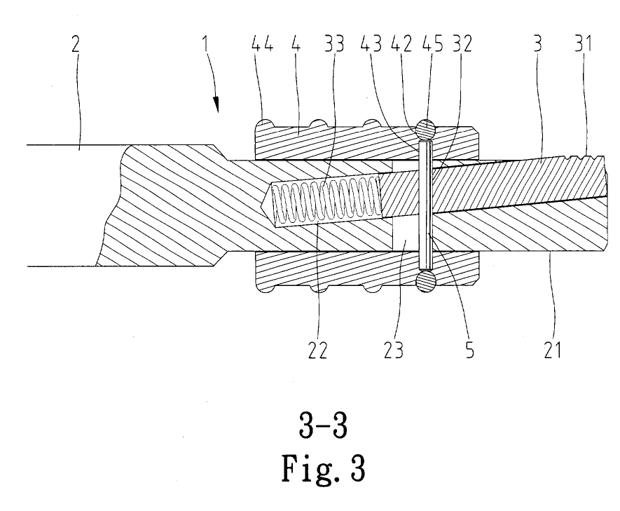

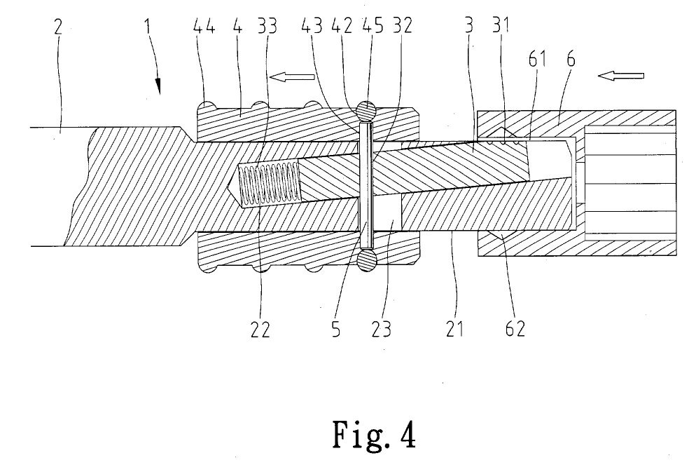

Referring to FIGS. 1-3, according to a first embodiment of the present invention, a connector 1 for connecting a tool handle (not shown) with a tool bit or socket 6 (FIGS. 4-7) is shown. The connector 1 includes an extension shank 2, a detent 3 and a switch 4.

The extension shank 2 includes a first end and a second end. A socket 24 is formed at the first end of the extension shank 2. The socket 24 defines a non-circular hole for receiving a corresponding end of the tool handle. Thus, pivoting of the handle causes pivoting of the extension shank 2. A non-circular insert 21 is formed at the second end of the extension shank 2 for insertion in a corresponding hole 61 defined in the tool bit or socket 6. Thus, rotation of the extension shank 2 causes rotation of the socket 6 or tool bit. The detent 3 and the switch 4 are installed at the second end of the extension shank 2 in order to control the engagement of the insert 21 with the socket 6.

The extension shank 2 defines a terminal hole 22. The length of the terminal hole 22 is not parallel to that of the extension shank 2. The extension shank 2 defines a peripheral hole or slot 5 communicated with the terminal hole 22.

A spring 33 is inserted in the terminal hole 22. The detent 3 is in the form of a rod. The detent 3 is movable inserted in the terminal hole 22. The detent 3 includes a first end and a second end. The first end of the detent 3 is biased by means of the spring 33 so that the second end of the detent 3 tends to extend from the terminal hole 22. A rough area 31 is formed on the detent 3 at or near the second end for firm engagement with the wall of the hole 61. The rough area 31 is a plurality of ribs. A hole 32 is defined in the detent 3 near the first end.

The switch 4 is in the form of a sleeve movably mounted on the second end of the extension shank 2. The switch 4 defines an axial hole 41 through which the second end of the extension shank 2 is inserted and a radial hole 43 communicated with the axial hole 41. A pin 5 is inserted through the holes 43 and 23 into the hole 32, thus combining the detent 3 with the switch 4. A ring 45 is mounted on the switch 4 so as to keep the pin 5 in position. An annular groove 42 is defined in the periphery of the switch 4 for receiving the ring 45. Several annular ribs 44 are formed on the periphery of the switch 4 for contact with a hand of a user (not shown).

Referring to FIG. 4, the user moves the second end of the detent 3 into the terminal hole 22 by way of pushing the switch 4. Then, the user inserts the insert 21 into the hole 61.

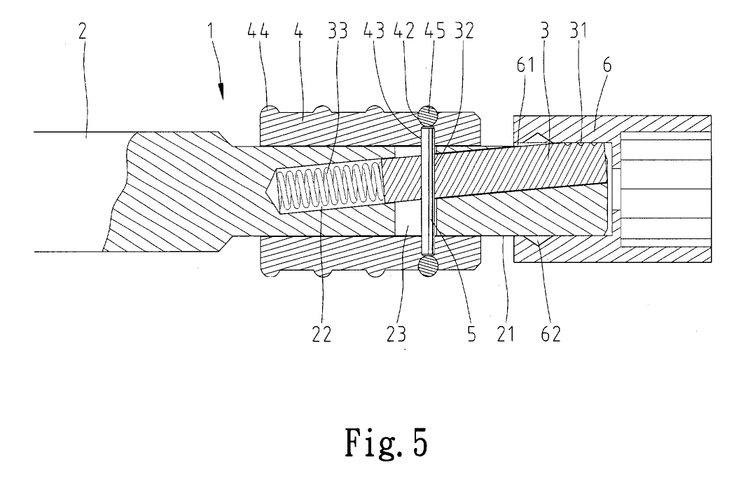

Referring to FIG. 5, the user releases the detent 3 via releasing the switch 4. As the detent 3 is biased by means of the spring 3.3, the second end of the detent 3 extends from the terminal hole 22 so as to abut against the wall of the hole 61.

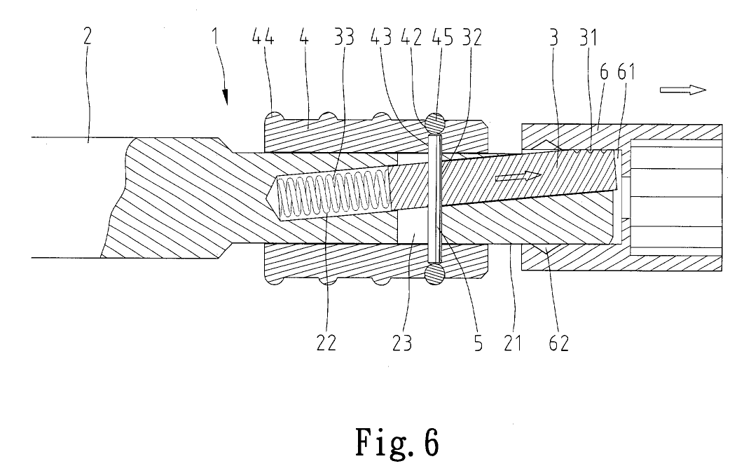

Referring to FIG. 6, if the user unintentionally pulls the socket 6 away from the extension shank 2, the user brings the second end of the detent 3 further from the terminal hole 22, thus enhancing the engagement of the second end of the detent 3 with the wall of the hole 61. Therefore, unintentional disengagement of the socket 6 from the extension shank 2 is avoided.

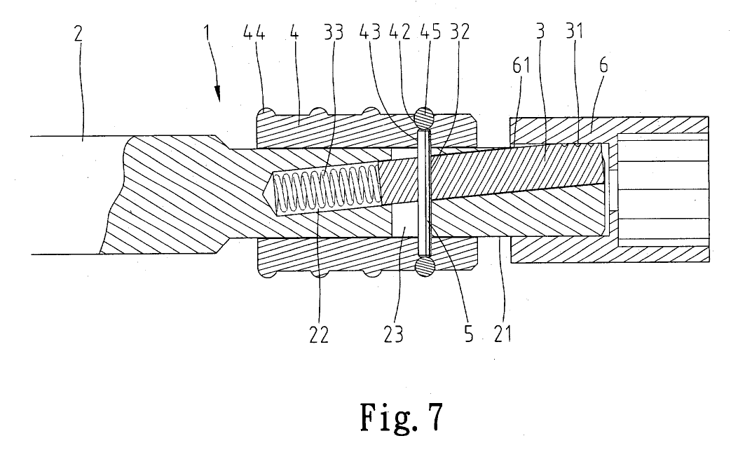

Referring to FIGS. 4-6, in the wall of the hole 61 is defined an annular groove 62 for receiving a ball detent of a typical connector (not shown). Referring to FIG. 7, the connector is used for connection with a socket 6′ different from the socket 6 in that it does not include the annular groove 62. It is obvious that the connector of the present invention can be used for connection with a socket with or without an annular groove such as the annular groove 62.

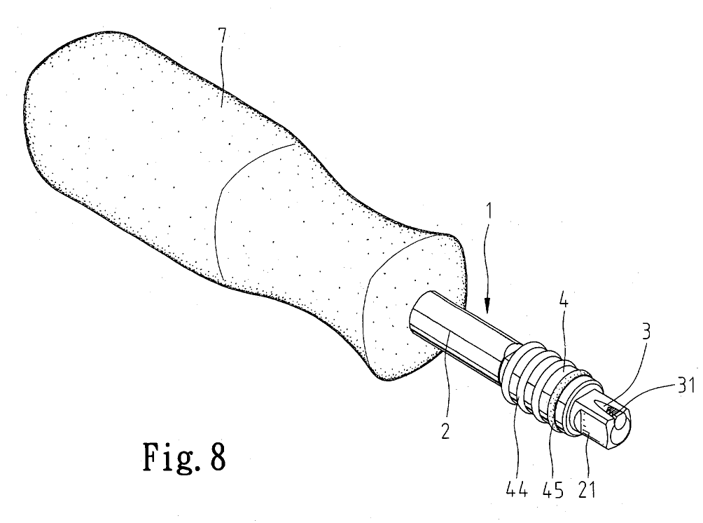

FIG. 8 shows a connector according to a second embodiment of the present invention. The second embodiment differs from the first embodiment in that the first end of the extension shank 2 is connected with a handle 7 instead of formed with the socket 24.

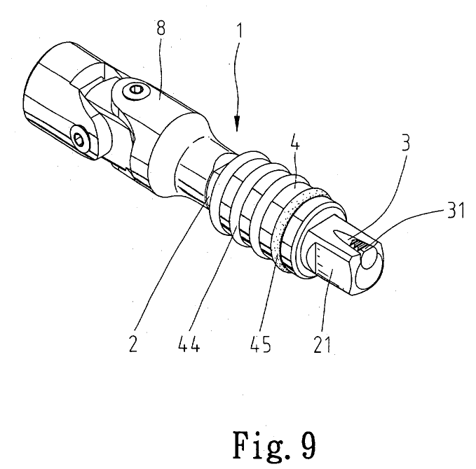

FIG. 9 is a perspective view of a connector according to a third embodiment of the present invention. The third embodiment differs from the first embodiment in that the first end of the extension shank 2 is formed with a universal joint 8 instead of the socket 24.

The present invention has been described via illustration of some embodiments. The applicant gives these embodiments only as examples, and those skilled in the art can derive variations from the embodiments after a study of this specification. Therefore, these embodiments shall not limit the scope of the present invention that is defined in the following claims.

What is claimed is:

1. A connector for connecting a tool handle with a tool bit, the connector including:
a shank including a first end, a second end, a non-circular insert formed at the second end for insertion in a corresponding hole defined in the tool bit, a terminal hole extending therein obliquely with respect thereto and a peripheral hole communicated with the terminal hole;
a spring inserted in the terminal hole;
a detent movably inserted in the terminal hole, the detent including a first end biased by means of the spring and a second end extensible from the terminal hole for engagement with the wall of the hole defined in the tool bit; and
a switch connected with the detent through the peripheral hole:

2. The connector according to claim 1 including a pin inserted through the peripheral hole and connected between the detent and the switch.

3. The connector according to claim 2 wherein the detent defines a hole for receiving the pin.

4. The connector according to claim 2 wherein the switch defines a hole for receiving the pin.

5. The connector according to claim 4 wherein the switch is a sleeve.

6. The connector according to claim 5 including a ring mounted on the sleeve for retaining the pin in position.

7. The connector according to claim 6 wherein the sleeve includes an annular groove defined in a periphery thereof for receiving the ring.

8. The connector according to claim 1 wherein the switch includes a plurality of ribs formed thereon.

9. The connector according to claim 1 wherein the detent includes a rough area formed thereon for firm engagement with the wall of the hole.

10. The connector according to claim 9 wherein the rough area is a plurality of ribs.

11. The connector according to claim 1 wherein the first end of the shank is formed with socket defining a non-circular hole for receiving a corresponding insert of the tool handle.

12. The connector according to claim 1 wherein the first end of the shank is connected with a handle.

13. The connector according to claim 1 wherein the first end of the shank is formed with a universal joint.
